(19) United States
(12) Patent Application Publication
(10) Pub. No.: US 2020/0115931 A1
(43) Pub. Date: Apr. 16, 2020

(54) VEHICLE KEY DETECTION AND STORAGE

(71) Applicant: GM GLOBAL TECHNOLOGY OPERATIONS LLC, Detroit, MI (US)

(72) Inventors: Erik M. ELBIEH, Royal Oak, MI (US); Christopher L. OESTERLING, Troy, MI (US)

(21) Appl. No.: 16/156,399

(22) Filed: Oct. 10, 2018

(51) Int. Cl. E05B 77/44; B60R 25/04; B60R 25/31; E05B 85/06

(52) U.S. Cl. CPC E05B 77/44; B60R 25/04; B60R 25/31; H04W 4/80; B60R 2325/10; E05Y 2400/458; E05B 85/06

(57) ABSTRACT

A system and method for securing a physical vehicle key at a vehicle, wherein the method is carried out by one or more electronic processors located at the vehicle, the method including the steps of: determining whether a vehicle key storage unit is in a lockable state, wherein the vehicle key storage unit includes a key hole for inserting the physical vehicle key and is located at the vehicle; when it is determined that the vehicle key storage unit is not in the lockable state, sending a notification to a vehicle user informing the vehicle user to place the physical vehicle key in the key hole; and when it is determined that the vehicle key storage unit is in the lockable state, engaging a key lock of the vehicle key storage unit so that the physical vehicle key is locked in and not removable from the key hole.

### INTRODUCTION

The present invention relates to configuring a vehicle for use in a vehicle sharing network and enabling access to the vehicle as a part of a vehicle reservation.

Vehicles include hardware and software capable of obtaining and processing various information, including information that is obtained by vehicle system modules (VSMs). Moreover, vehicles include networking capabilities and can be connected to a vehicle backend server that maintains accounts for users and their vehicles. Users may allow another user to borrow their vehicle or to lease their vehicle as a part of a peer-to-peer (P2P) vehicle sharing network. Some such vehicles may utilize a physical key to enable operation of the vehicle, in which case the key must be returned by a user of the P2P vehicle sharing network after their reservation terminates and must be made available to the next person using the vehicle.

### SUMMARY

According to one aspect of the invention, there is provided a method of securing a physical vehicle key at a vehicle, wherein the method is carried out by one or more electronic processors located at the vehicle, the method including the steps of: determining whether a vehicle key storage unit is in a lockable state, wherein the vehicle key storage unit includes a key hole for inserting the physical vehicle key and is located at the vehicle; when it is determined that the vehicle key storage unit is not in the lockable state, sending a notification to a vehicle user informing the vehicle user to place the physical vehicle key in the key hole; and when it is determined that the vehicle key storage unit is in the lockable state, engaging a key lock of the vehicle key storage unit so that the physical vehicle key is locked in and not removable from the key hole.

According to various embodiments, this method may further include any one of the following features or any technically-feasible combination of some or all of these features:
the vehicle key storage unit includes a key cylinder that is moveable between a locked position and an unlocked position and wherein it is determined that the vehicle key storage unit is in the lockable state when it is determined that the key cylinder is in the locked position;
the key cylinder is a non-ignition key cylinder;
the vehicle key storage unit is an aftermarket device that includes the one or more electronic processors and that is separate from vehicle electronics of the vehicle;
the vehicle key storage unit includes a short-range wireless communications (SRWC) circuit, and wherein the vehicle key storage unit receives a key lock engage command from a wireless communications device of the vehicle or from a personal SRWC device;
the determining step is carried out in response to an indication that a vehicle sharing reservation has ended;
the indication that the vehicle sharing reservation has ended is received from the personal SRWC device and in response to the vehicle user indicating an end of the reservation via a device-user interface of the personal SRWC device;
the notification is sent to the wireless communications device of the vehicle or the personal SRWC device via the SRWC circuit of the vehicle key storage unit;
the key cylinder is an ignition key cylinder of the vehicle and wherein the locked position of the key cylinder is a dedicated key storage position for purposes of storing the physical vehicle key when the vehicle is not being operated;
disengaging the key lock of the vehicle key storage unit in response to receiving a key lock disengage request message;
the key lock disengage request message is sent in response to determining that the vehicle user is authorized to access the vehicle;
the key lock disengage request message is sent in response to detecting that the vehicle user is at the vehicle; and/or
the determining step is carried out by vehicle electronics of the vehicle or wherein the determining step is carried out by the vehicle key storage unit.

According to another aspect of the invention, there is provided a vehicle key storage unit for securing a physical vehicle key at a vehicle, including: a key lock that is operable between an engaged state and a disengaged state; a key hole that is configured to receive the physical vehicle key for the vehicle; a processor; and memory communicatively coupled to the processor, wherein the memory stores a computer program; wherein the processor operates under control of the computer program to cause the vehicle key storage unit to: engage the key lock so that the key lock is set to the engaged state in response to receiving a key lock engage command from a vehicle or a personal short-range wireless communications (SRWC) device, wherein the key lock in the engaged state locks the physical vehicle key in the key hole such that the physical vehicle key is prevented from being removed from the key hole; and disengage the key lock in response to receiving a key lock disengage command from the vehicle or the personal short-range wireless communications (SRWC) device.

According to various embodiments, this vehicle key storage unit may further include any one of the following features or any technically-feasible combination of some or all of these features:
the vehicle key storage unit is an aftermarket device;
the vehicle key storage unit includes a housing that is separate from the vehicle;
the vehicle key storage unit further includes a short-range wireless communications (SRWC) circuit;
the vehicle key storage unit further includes a key cylinder in which the key hole is located, and wherein key cylinder is moveable between a locked position and an unlocked position;
the processor operates under the control of the computer program to cause the vehicle key storage unit to engage the key lock when it is determined that the key cylinder is in the locked position; and/or
the vehicle key storage unit is hardwired to a communications bus of a vehicle.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein;

FIG. 2 is a block diagram depicting an embodiment of a vehicle key storage unit;

FIGS. 3A-3B are block diagrams depicting a key cylinder unit of the vehicle key storage unit in an unlocked position (FIG. 3A) and a locked position (FIG. 3B);

FIG. 4 is a flowchart of an embodiment of a method of establishing a vehicle reservation;

FIG. 5 is a flowchart of an embodiment of a method of controlling a vehicle key storage unit at a vehicle; and

FIG. 6 is a flowchart of an embodiment of a method of securing a physical vehicle key at a vehicle.

### DETAILED DESCRIPTION

The system and method described below can be used at a vehicle for storage and locking of a physical key that is used for enabling operation of the vehicle (e.g., an ignition key). This can be done using a lockable vehicle key storage unit. Also, in at least some embodiments, the method can be used for determining (or verifying) that a physical key has been stored in and is presently located at the vehicle key storage unit. In many embodiments, the vehicle key storage unit is located at a vehicle and the vehicle key storage unit is configured to receive a physical vehicle key. In an example scenario, a vehicle owner (or manager) desires to rent their vehicle out to other vehicle users (or vehicle renters). In such a case, the vehicle owner (or manager) can place the vehicle key in a key hole of the vehicle key storage unit and then engage a key lock that secures or locks the vehicle key in the key hole of the vehicle key storage unit such that the key cannot be removed from the key hole. Then, when a vehicle renter (or other vehicle user) is granted permission to operate the vehicle, such as a part of a car sharing reservation, the vehicle can detect the presence of the vehicle renter (or other authorized vehicle user) at the vehicle and can then disengage the key lock so that the key can be removed from the key hole. Then, for example, upon the reservation ending, the vehicle renter can place the key in the key hole of the vehicle key storage unit and the key lock can engage and lock the key in the key hole. The vehicle renter, the vehicle owner (or manager), or a remote vehicle services facility can be informed of the status of the vehicle key storage unit and, thus, can be aware of whether the key is engaged and locked in the vehicle key storage unit. In at least some scenarios, this can provide a mechanism for verifying that a vehicle renter has left the vehicle key at the vehicle at the end of the car sharing (or vehicle sharing) reservation.

In many embodiments, the vehicle key storage unit includes a key cylinder in which the key hole is located, and this key cylinder can be separate from a key ignition cylinder of the vehicle that is used to activate the vehicle's ignition (or other primary mover). The key cylinder can be moveable (e.g., rotatable) between a locked and an unlocked state. These states of the key cylinder can correspond to a position of the key cylinder relative to a key cylinder mount (or body surrounding the key cylinder). In the unlocked state, the key can be inserted and removed and, in the locked state, the key is not removable. When the key is placed in the key cylinder and then rotated (or otherwise moved) to the locked position, the key lock can engage the key cylinder such that the key cylinder is not rotatable (or at least not rotatable to the unlocked state (or other state/position in which the key can be removed)). In one embodiment, the key lock moves a locking member through a locking member through-hold of the key cylinder (or coupled to the key cylinder) that prevents the key cylinder from being rotated and, thus, prevents the key from being removed.

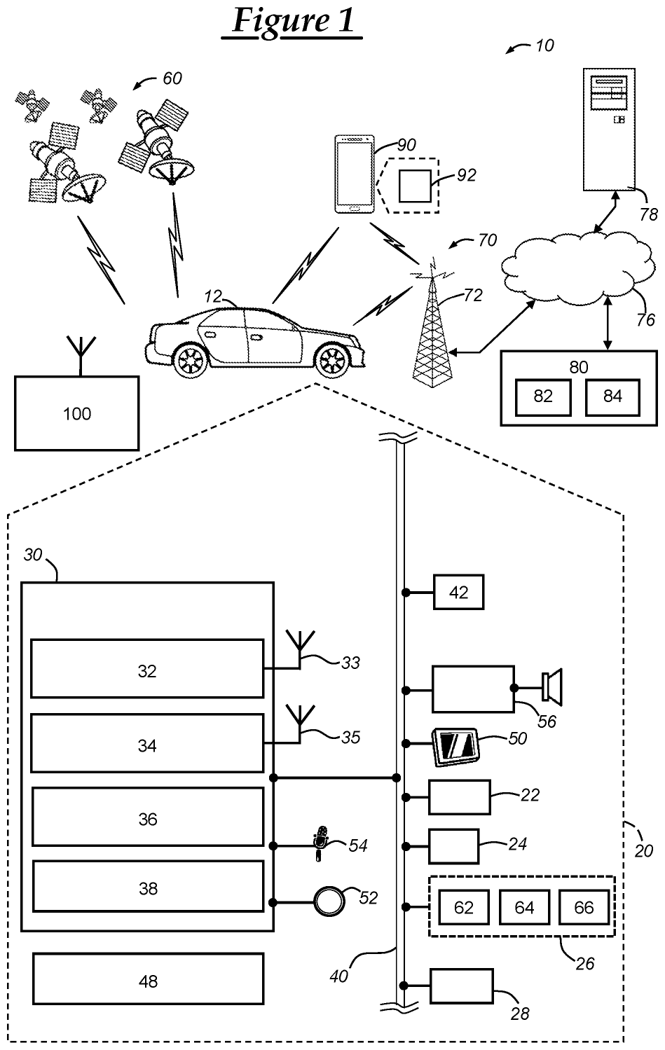

With reference to FIG. 1, there is shown an operating environment that comprises a communications system 10 and that can be used to implement the method disclosed herein. Communications system 10 generally includes a vehicle 12, a constellation of global navigation satellite system (GNSS) satellites 60, one or more wireless carrier systems 70, a land communications network 76, a computer or server 78, and a vehicle backend services facility 80. It should be understood that the disclosed method can be used with any number of different systems and is not specifically limited to the operating environment shown here. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft including unmanned aerial vehicles (UAVs), etc., can also be used. Some of the vehicle electronics 20 are shown generally in FIG. 1 and includes a global navigation satellite system (GNSS) receiver 22, a body control module or unit (BCM) 24, an engine control module (ECM) 26, other vehicle system modules (VSMs) 28, a wireless communications device 30, a vehicle key storage unit 100, and vehicle-user interfaces 50-56. Some or all of the different vehicle electronics may be connected for communication with each other via one or more communication busses, such as communications bus 40. The communications bus 40 provides the vehicle electronics with network connections using one or more network protocols and can use a serial data communication architecture. Examples of suitable network connections include a controller area network (CAN), a media oriented system transfer (MOST), a local interconnection network (LIN), a local area network (LAN), and other appropriate connections such as Ethernet or others that conform with known ISO, SAE, and IEEE standards and specifications, to name but a few.

The vehicle 12 can include numerous vehicle system modules (VSMs) as part of vehicle electronics 20, such as the GNSS receiver 22, BCM 24, ECM 26, wireless communications device 30, and vehicle-user interfaces 50-56, as will be described in detail below. In one embodiment, the vehicle 12 is a non-passive entry passive start (non-PEPS) vehicle in that the vehicle does not permit access to the cabin (or other lockable part of the vehicle) and/or the ignition (or other primary mover) to be started via a PEPS module. The vehicle 12 can also include other VSMs 28 in the form of electronic hardware components that are located throughout the vehicle and, which may receive input from one or more sensors and use the sensed input to perform diagnostic, monitoring, control, reporting, and/or other functions. Each of the VSMs 28 can be connected by communications bus 40 to the other VSMs, as well as to the wireless communications device 30, and can be programmed to run vehicle system and subsystem diagnostic tests. Moreover, each of the VSMs can include and/or be communicatively coupled to suitable hardware that enables intra-vehicle communications to be carried out over the communications bus 40; such hardware can include, for example, bus interface connectors and/or modems. One or more VSMs 28 may periodically or occasionally have their software or firmware updated and, in some embodiments, such vehicle updates may be over the air (OTA) updates that are received from a computer 78 or remote facility 80 via land network 76 and communications device 30. As is appreciated by those skilled in the art, the above-mentioned VSMs are only examples of some of the modules that may be used in vehicle 12, as numerous others are also possible.

Global navigation satellite system (GNSS) receiver 22 receives radio signals from a constellation of GNSS satellites 60. The GNSS receiver 22 can be configured for use with various GNSS implementations, including global positioning system (GPS) for the United States, BeiDou Navigation Satellite System (BDS) for China, Global Navigation Satellite System (GLONASS) for Russia, Galileo for the European Union, and various other navigation satellite systems. For example, the GNSS receiver 22 may be a GPS receiver, which may receive GPS signals from a constellation of GPS satellites 60. And, in another example, GNSS receiver 22 can be a BDS receiver that receives a plurality of GNSS (or BDS) signals from a constellation of GNSS (or BDS) satellites 60. In either implementation, GNSS receiver 22 can include at least one processor and memory, including a non-transitory computer readable memory storing instructions (software) that are accessible by the processor for carrying out the processing performed by the receiver 22.

Body control module (BCM) 24 can be used to control various VSMs of the vehicle, as well as obtain information concerning the VSMs, including their present state or status, as well as sensor information. The BCM 24 is shown in the exemplary embodiment of FIG. 1 as being electrically coupled to the communication bus 40. In some embodiments, the BCM 24 may be integrated with or part of a center stack module (CSM) and/or integrated with wireless communications device 30. Or, the BCM may be a separate device that is connected to other VSMs via bus 40. The BCM 24 can include a processor and/or memory, which can be similar to processor 36 and memory 38 of wireless communications device 30, as discussed below. The BCM 24 may communicate with wireless device 30 and/or one or more vehicle system modules, such as the engine control module (ECM) 26, audio system 56, or other VSMs 28; in some embodiments, the BCM 24 can communicate with these modules via the communications bus 40. The BCM 24 may include a processor and memory accessible by the processor. Software stored in the memory and executable by the processor enables the BCM to direct one or more vehicle functions or operations including, for example, controlling central locking, air conditioning, power mirrors, controlling the vehicle primary mover (e.g., engine, primary propulsion system), and/or controlling various other vehicle modules.

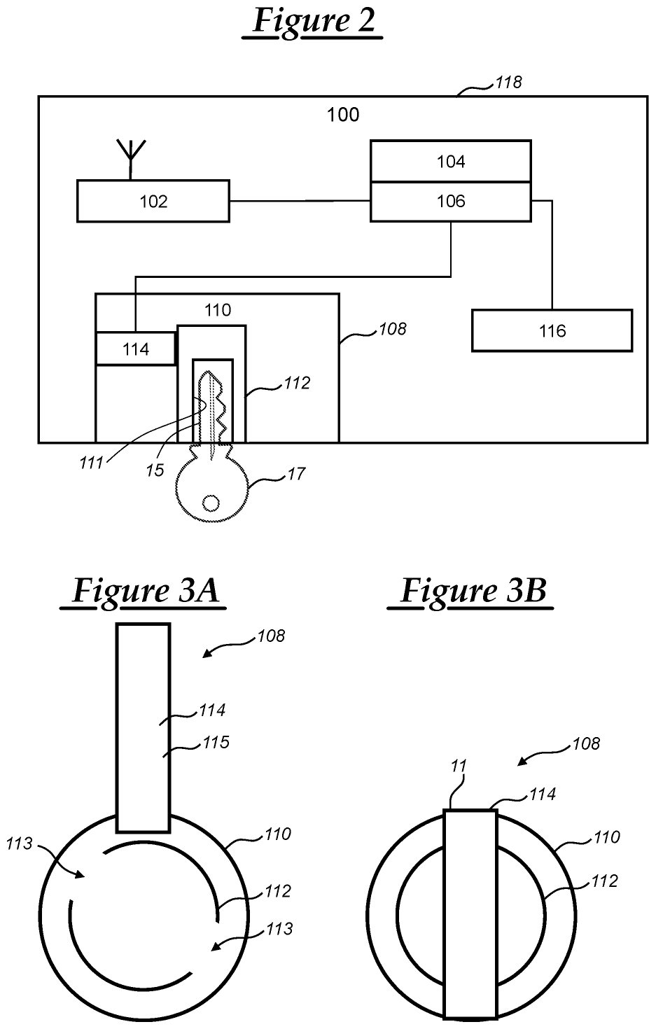

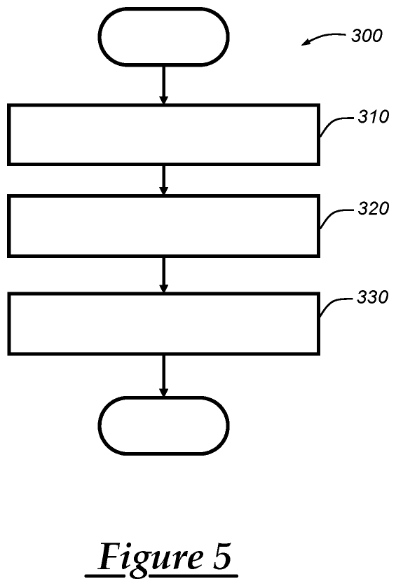

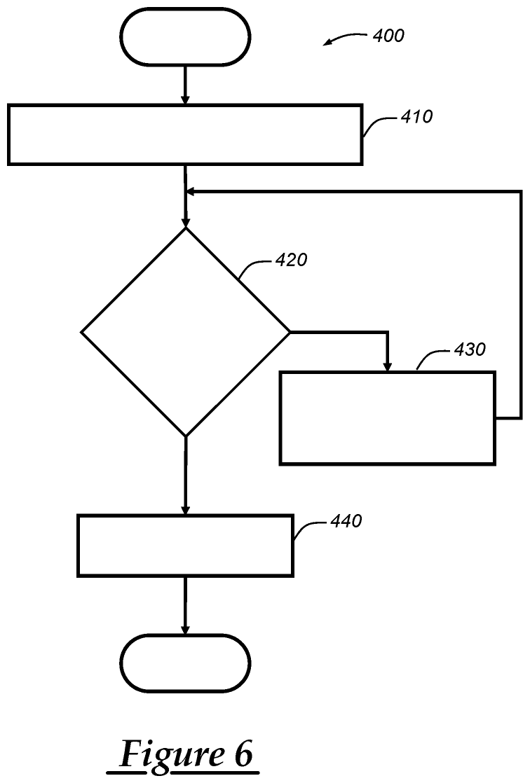

In one embodiment, the BCM 24 is coupled to an ignition unit that can be communicatively coupled (e.g., via communications bus 24) to a key ignition cylinder 42. The key ignition cylinder is a key cylinder that can receive a corresponding physical vehicle key and that, when a corresponding physical key is properly engaged in the key ignition cylinder, the key ignition cylinder can be rotated (or otherwise operated) to start the vehicle's ignition (or other primary mover). A corresponding physical key is a key that can be engaged in the key cylinder and used to rotate (or otherwise operate) the key cylinder. The key ignition cylinder 42 can include a sensor that can sense the position of the corresponding physical key in the key ignition cylinder (e.g., off position (OFF), accessory position (ACC), start position (START), or on position (ON)). In some embodiments, the method 300 (FIG. 5) and/or the method 400 (FIG. 6) discussed below can be used with the key ignition cylinder to detect whether the corresponding physical key is engaged (and/or in the storage position) in the key ignition cylinder 42. In another embodiment, the key ignition unit 42 can include an additional storage position (STORAGE) in which the key can be locked in the key cylinder. In such an embodiment, this storage position can allow the vehicle system (e.g., via a command from the BCM 24) to lock the corresponding physical key in the key cylinder such that the physical key is not removable from the key cylinder. And, in one embodiment, when the physical key is in this storage position, the vehicle electronics 20 are not supplied energy or the vehicle operates in a low power mode, which can be the same or similar to the mode that the vehicle operates in when the vehicle is turned off (e.g., the vehicle key is in the OFF position). In one embodiment, the key ignition unit can also detect whether the key is in the lock position and/or whether the “key lock” is engaged (i.e., in the locked position). As used herein, the term “key lock” refers to a locking mechanism that locks a physical key within a key hole of a key storage unit when the key lock is in the locked (or engaged) position. In one embodiment, the key lock can lock the physical key within the cylinder by moving a locking member that blocks rotation of the key cylinder to the unlocked state (for example, see FIGS. 3A and 3B). In another embodiment, the key lock can be a mechanism that prevents the pins from disengaging the key cuts. Various other locking mechanisms are possible as well, such as those discussed below with respect to the key lock 114 (FIG. 2) of the vehicle key storage unit 100. In one embodiment, the key lock can be controlled by the BCM 24, the wireless communications device 30, and/or other VSM. And, as discussed below, in another embodiment, the physical vehicle key that is used in the key ignition cylinder can be stored in a separate key cylinder of the vehicle key storage unit 100.

Engine control module (ECM) 26 may control various aspects of engine operation such as fuel ignition and ignition timing. The ECM 26 is connected to the communications bus 40 and may receive operation instructions (or vehicle commands) from the BCM 24 or other vehicle system modules, such as the wireless communications device 30 or other VSMs 28. In one scenario, the ECM 26 may receive a command from the BCM to start the vehicle—i.e., initiate the vehicle ignition or other primary propulsion system (e.g., a battery powered motor). Moreover, the ECM 26 can be used as an onboard vehicle sensor that can obtain vehicle sensor information of the vehicle engine, such as from engine speed sensor 62, engine temperature sensor 64, and engine ignition timing sensor 66, all of which are also onboard vehicle sensors. In embodiments when the vehicle is a hybrid or electric vehicle, the ECM 26 can be used to obtain status information regarding the primary mover (including electrical motor(s) and battery information).

As used herein, a “powered on state” is a state of the vehicle in which the ignition or primary propulsion system of the vehicle is powered on and, as used herein, a “powered off state” is a state of the vehicle in which the ignition or primary propulsion system of the vehicle is not powered on. Moreover, the powered on state can include instances in which the accessory electronics of the vehicle, such as the auxiliary power port 48, is supplied with electrical power. For example, this accessory power mode may be when a physical key is within the key ignition cylinder and in an accessory (ACC) position/mode.

Auxiliary power port 48 can be any type of port that can be used to provide power from a vehicle battery. The auxiliary power port 48 can be a cigarette lighter socket, a universal serial bus (USB) port, a coaxial direct current (DC) input, a power outlet (e.g., a 120-Volt power outlet), and/or various other ports or connectors that are electrically coupled to the vehicle battery such that electrical charge from the vehicle battery can be supplied thereto. For example, the battery 116 (FIG. 2) of the vehicle key storage unit 100 can be connected to the auxiliary power port 48 via a hardwire connection (e.g., a USB cable) and the auxiliary power port 48 can then supply electrical power to the battery 116 (FIG. 2). In many embodiments, the auxiliary power port 48 may only be supplied power from the vehicle battery when the vehicle is in a powered on state.

Wireless communications device 30 is capable of communicating data via short-range wireless communications (SRWC) through use of SRWC circuit 32 and/or via cellular network communications through use of a cellular chipset 34, as depicted in the illustrated embodiment. In one embodiment, the wireless communications device 30 is a central vehicle computer that can be used to carry out various vehicle tasks. In the illustrated embodiment, wireless communications device 30 includes an SRWC circuit 32, a cellular chipset 34, a processor 36, memory 38, and antennas 33 and 35. In one embodiment, wireless communications device 30 may be a standalone module or, in other embodiments, device 30 may be incorporated or included as a part of one or more other vehicle system modules, such as a car sharing module, center stack module (CSM), body control module (BCM) 24, an infotainment module, a head unit, and/or a gateway module. In some embodiments, the device 30 can be implemented as an OEM-installed (embedded) or aftermarket device that is installed in the vehicle. In some embodiments, the wireless communications device 30 is a telematics unit (or telematics control unit) that is capable of carrying out cellular communications using one or more cellular carrier systems 70. Or, in other embodiments, a separate telematics unit can be included in the vehicle and communicatively coupled to the wireless communications device 30. The telematics unit can be integrated with the GNSS receiver 22 so that, for example, the GNSS receiver 22 and the wireless communications device (or telematics unit) 30 are directly connected to one another as opposed to being connected via communications bus 40.

In some embodiments, the wireless communications device 30 can be configured to communicate wirelessly according to one or more short-range wireless communications (SRWC) such as any of the Wi-Fi™, WiMAX™, Wi-Fi™ Direct, other IEEE 802.11 protocols, ZigBee™, Bluetooth™, Bluetooth™ Low Energy (BLE), or near field communication (NFC). As used herein, Bluetooth™ refers to any of the Bluetooth™ technologies, such as Bluetooth Low Energy™ (BLE), Bluetooth™ 4.1, Bluetooth™ 4.2, Bluetooth™ 5.0, and other Bluetooth™ technologies that may be developed. As used herein, Wi-Fi™ or Wi-Fi™ technology refers to any of the Wi-Fi™ technologies, such as IEEE 802.11b/g/n/ac or any other IEEE 802.11 technology. The short-range wireless communication (SRWC) circuit 32 enables the wireless communications device 30 to transmit and receive SRWC signals, such as BLE signals. The SRWC circuit may allow the device 30 to connect to another SRWC device, such as the vehicle key storage unit 100 (FIG. 2). Additionally, in some embodiments including the depicted embodiment, the wireless communications device 30 contains a cellular chipset 34 thereby allowing the device to communicate via one or more cellular protocols, such as those used by cellular carrier system 70. In such a case, the wireless communications device becomes user equipment (UE) usable in carrying out cellular communications via cellular carrier system 70.

Wireless communications device 30 may enable vehicle 12 to be in communication with one or more remote networks (e.g., one or more networks at remote facility 80 or computers 78) via packet-switched data communication. This packet-switched data communication may be carried out through use of a non-vehicle wireless access point that is connected to a land network via a router or modem. When used for packet-switched data communication such as TCP/IP, the communications device 30 can be configured with a static IP address or can be set up to automatically receive an assigned IP address from another device on the network such as a router or from a network address server.

Packet-switched data communications may also be carried out via use of a cellular network that may be accessible by the device 30. Communications device 30 may, via cellular chipset 34, communicate data over wireless carrier system 70. In such an embodiment, radio transmissions may be used to establish a communications channel, such as a voice channel and/or a data channel, with wireless carrier system 70 so that voice and/or data transmissions can be sent and received over the channel. Data can be sent either via a data connection, such as via packet data transmission over a data channel, or via a voice channel using techniques known in the art. For combined services that involve both voice communication and data communication, the system can utilize a single call over a voice channel and switch as needed between voice and data transmission over the voice channel, and this can be done using techniques known to those skilled in the art.

Processor 36 can be any type of device capable of processing electronic instructions including microprocessors, microcontrollers, host processors, controllers, vehicle communication processors, and application specific integrated circuits (ASICs). It can be a dedicated processor used only for communications device 30 or can be shared with other vehicle systems. Processor 36 executes various types of digitally-stored instructions, such as software or firmware programs stored in memory 38, which enable the device 30 to provide a wide variety of services. For instance, processor 36 can execute programs or process data to carry out at least a part of the method discussed herein. Memory 38 may include any suitable non-transitory, computer-readable medium; these include different types of RAM (random-access memory, including various types of dynamic RAM (DRAM) and static RAM (SRAM)), ROM (read-only memory), solid-state drives (SSDs) (including other solid-state storage such as solid state hybrid drives (SSHDs)), hard disk drives (HDDs), magnetic or optical disc drives, that stores some or all of the software needed to carry out the various external device functions discussed herein.

The wireless communications device 30 can interface various VSMs of the vehicle 12 with one or more devices external to the vehicle 12, such as one or more networks or systems at remote facility 80. This enables the vehicle to communicate data or information with remote systems, such as remote facility 80. Additionally, the wireless communications device 30 can enable the vehicle to be remotely configured by a remote facility or server or personal short-range wireless communication (SRWC) device. For example, the wireless communications device 30 can receive a key lock engage status inquiry from the personal SRWC device 90 or the remote facility 80. This key lock engage inquiry can be a request (or an indication) to check the status of whether a physical key is engaged in a key cylinder, whether the physical key is engaged in the key cylinder and in the STORAGE position, and/or whether the key lock is engaged. The key lock (or key cylinder) status can then be communicated back to the personal SRWC device 90 (or remote facility 80).

Vehicle electronics 20 also includes a number of vehicle-user interfaces that provide vehicle occupants with a means of providing and/or receiving information, including visual display 50, pushbutton(s) 52, microphone 54, and audio system 56. As used herein, the term “vehicle-user interface” broadly includes any suitable form of electronic device, including both hardware and software components, which is located on the vehicle and enables a vehicle user to communicate with or through a component of the vehicle. The pushbutton(s) 52 allow manual user input into the communications device 30 to provide other data, response, and/or control input. Audio system 56 provides audio output to a vehicle occupant and can be a dedicated, stand-alone system or part of the primary vehicle audio system. According to one embodiment, audio system 56 is operatively coupled to both vehicle bus 40 and an entertainment bus (not shown) and can provide AM, FM and satellite radio, CD, DVD and other multimedia functionality. This functionality can be provided in conjunction with or independent of an infotainment module. Microphone 54 provides audio input to the wireless communications device 30 to enable the driver or other occupant to provide voice commands and/or carry out hands-free calling via the wireless carrier system 70. For this purpose, it can be connected to an on-board automated voice processing unit utilizing human-machine interface (HMI) technology known in the art. Visual display or touch screen 50 is preferably a graphics display and can be used to provide a multitude of input and output functions. Display 50 can be a touch screen on the instrument panel, a heads-up display reflected off of the windshield, or a projector that can project graphics for viewing by a vehicle occupant. Various other vehicle-user interfaces can also be utilized, as the interfaces of FIG. 1 are only an example of one particular implementation.

Wireless carrier system 70 may be any suitable cellular telephone system. Carrier system 70 is shown as including a cellular tower 72; however, the carrier system 70 may include one or more of the following components (e.g., depending on the cellular technology): cellular towers, base transceiver stations, mobile switching centers, base station controllers, evolved nodes (e.g., eNodeBs), mobility management entities (MMEs), serving and PGN gateways, etc., as well as any other networking components required to connect wireless carrier system 70 with the land network 76 or to connect the wireless carrier system with user equipment (UEs, e.g., which can include telematics equipment in vehicle 12). Carrier system 70 can implement any suitable communications technology, including GSM/GPRS technology, CDMA or CDMA2000 technology, LTE technology, etc. In general, wireless carrier systems 70, their components, the arrangement of their components, the interaction between the components, etc. is generally known in the art.

Apart from using wireless carrier system 70, a different wireless carrier system in the form of satellite communication can be used to provide uni-directional or bi-directional communication with a vehicle. This can be done using one or more communication satellites (not shown) and an uplink transmitting station (not shown). Uni-directional communication can be, for example, satellite radio services, wherein programming content (news, music, etc.) is received by the uplink transmitting station, packaged for upload, and then sent to the satellite, which broadcasts the programming to subscribers. Bi-directional communication can be, for example, satellite telephony services using the one or more communication satellites to relay telephone communications between the vehicle 12 and the uplink transmitting station. If used, this satellite telephony can be utilized either in addition to or in lieu of wireless carrier system 70.

Land network 76 may be a conventional land-based telecommunications network that is connected to one or more landline telephones and connects wireless carrier system 70 to remote facility 80. For example, land network 76 may include a public switched telephone network (PSTN) such as that used to provide hardwired telephony, packet-switched data communications, and the Internet infrastructure. One or more segments of land network 76 could be implemented through the use of a standard wired network, a fiber or other optical network, a cable network, power lines, other wireless networks such as wireless local area networks (WLANs), networks providing broadband wireless access (BWA), or any combination thereof.

The computers 78 (only one shown in FIG. 1) can be used for one or more purposes, such as for providing peer-to-peer (P2P) vehicle sharing services to a plurality of vehicles and other electronic network computing devices, including vehicle 12. The computers 78 can be some of a number of computers accessible via a private or public network such as the Internet. Other such accessible computers 78 can be, for example: a service center computer where diagnostic information and other vehicle data can be uploaded from the vehicle; a client computer used by the vehicle owner or other subscriber for various purposes, such as accessing and/or receiving vehicle sensor data (or other data), as well as setting up and/or configuring subscriber preferences or controlling vehicle functions; or a vehicle sharing server which coordinates registrations from a plurality of users who request to use a vehicle as part of a car sharing service. A computer 78 can also be used for providing Internet connectivity such as DNS services or as a network address server that uses DHCP or other suitable protocol to assign an IP address to vehicle 12.

Vehicle backend services facility 80 is a remote facility, meaning that it is located at a physical location that is located remotely from vehicle 12. The vehicle backend services facility 80 (or remote facility 80) may be designed to provide the vehicle electronics 20 with a number of different system back-end functions through use of one or more electronic servers 82. The vehicle backend services facility 80 includes vehicle backend services servers 82 and databases 84, which may be stored on a plurality of memory devices. Also, remote facility 80 can include one or more switches, one or more live advisors, and/or an automated voice response system (VRS), all of which are known in the art. Vehicle backend services facility 80 may include any or all of these various components and, preferably, each of the various components are coupled to one another via a wired or wireless local area network. Remote facility 80 may receive and transmit data via a modem connected to land network 76. Data transmissions may also be conducted by wireless systems, such as IEEE 802.11x, GPRS, and the like. Those skilled in the art will appreciate that, although only one remote facility 80 and one computer 78 are depicted in the illustrated embodiment, numerous remote facilities 80 and/or computers 78 may be used.

Servers 82 can be computers or other computing devices that include at least one processor and memory. The processors can be any type of device capable of processing electronic instructions including microprocessors, microcontrollers, host processors, controllers, vehicle communication processors, and application specific integrated circuits (ASICs). The processors can be dedicated processors used only for servers 82 or can be shared with other systems. The at least one processor can execute various types of digitally-stored instructions, such as software or firmware, which enable the servers 82 to provide a wide variety of services. For network communications (e.g., intra-network communications, inter-network communications including Internet connections), the servers can include one or more network interface cards (NICs) (including, for example, wireless NICs (WNICs)) that can be used to transport data to and from the computers. These NICs can allow the one or more servers 82 to connect with one another, databases 84, or other networking devices, including routers, modems, and/or switches. In one particular embodiment, the NICs (including WNICs) of servers 82 may allow SRWC connections to be established and/or may include Ethernet (IEEE 802.3) ports to which Ethernet cables may be connected to that can provide for a data connection between two or more devices. Remote facility 80 can include a number of routers, modems, switches, or other network devices that can be used to provide networking capabilities, such as connecting with land network 76 and/or cellular carrier system 70.

Databases 84 can be stored on a plurality of memory, such as a powered temporary memory or any suitable non-transitory, computer-readable medium; these include different types of RAM (random-access memory, including various types of dynamic RAM (DRAM) and static RAM (SRAM)), ROM (read-only memory), solid-state drives (SSDs) (including other solid-state storage such as solid state hybrid drives (SSHDs)), hard disk drives (HDDs), and magnetic or optical disc drives. One or more databases at the backend facility 80 can store various information and can include a vehicle reservation database and other vehicle backend information database(s). The vehicle reservation database can store reservation information for use in carrying out a reservation of a P2P vehicle.

In some embodiments, the remote facility 80 can use the information stored in databases 84 to carry out one or more embodiments of the reservation establishment process so that a vehicle user can establish a reservation for use of a vehicle, such as a vehicle that is a part of a P2P vehicle sharing network. As mentioned above, although only a single vehicle backend services facility 80 is illustrated, numerous vehicle backend services facilities can be used and, in such a case, the functionality of the numerous vehicle backend services facilities can be coordinated so that the vehicle backend services facilities can act as a single backend network or so that the operation of each facility is coordinated with the operation of the other facilities. And, the servers 82 can be used to provide information stored in the databases 84 to various other systems or devices, such as vehicle 12.

The personal short-range wireless communication (SRWC) device 90 is a mobile devices and may include: hardware, software, and/or firmware enabling SRWC as well as other personal (or mobile) device applications. In one embodiment, the personal SRWC device 90 can include a vehicle-device application 92 and a global navigation satellite system (GNSS) receiver. According to various embodiments, the personal SRWC device can include Android™, iOS™, Windows™ Phone, Windows™ Mobile, BlackBerry™ Tizen™, and/or other various operating systems. In one particular embodiment, the personal SRWC device can be a personal cellular SRWC device that includes a cellular chipset and/or cellular connectivity capabilities, as well as SRWC capabilities. Using a cellular chipset, for example, the personal SRWC device can connect with various remote devices, including computers 78 and remote server facility 80, via wireless carrier system 70. As used herein, a personal SRWC device is a mobile device that is capable of SRWC, that is portable by a user, and where the portability of the device is at least partly dependent on the user, such as a wearable device (e.g., a smartwatch), an implantable device, or a handheld device (e.g., a smartphone, a tablet, a laptop). As used herein, a short-range wireless communications (SRWC) device is a device capable of SRWC. The hardware of SRWC mobile device 90 may comprise: a processor and memory (e.g., non-transitory computer readable medium configured to operate with the processor) for storing the software, firmware, etc. The personal SRWC device's processor and memory may enable various software applications, which may be preinstalled or installed by the user (or manufacturer) (e.g., having a software application or graphical user interface (GUI)).

As mentioned, the personal SRWC device 90 can include a processor and memory. The processor (or processing device) can be any type of device capable of processing electronic instructions including microprocessors, microcontrollers, host processors, controllers, and application specific integrated circuits (ASICs). The processor of the personal SRWC device 90 executes various types of digitally-stored instructions, such as software or firmware programs stored in memory of the personal SRWC device, which enable the device 90 to provide a wide variety of services. The memory of the personal SRWC device may include any suitable non-transitory, computer-readable medium; these include different types of RAM (random-access memory, including various types of dynamic RAM (DRAM) and static RAM (SRAM)), ROM (read-only memory), solid-state drives (SSDs) (including other solid-state storage such as solid state hybrid drives (SSHDs)), hard disk drives (HDDs), magnetic or optical disc drives, that stores some or all of the software needed to carry out the various external device functions discussed herein. In one embodiment, the personal SRWC device 90 can be used to determine a location of the personal SRWC device. Such devices may communicate with wireless communications device 30 or with each other according to one or more SRWC technologies or wired connections, such as a connection using a Universal Serial Bus (USB) cable. In one embodiment, the personal SRWC device 90 can be used to authenticate and/or authorize a user for access to the vehicle 12 as a part of an established reservation.

For example, a user (e.g., P2P vehicle renter) of the personal SRWC device 90 can use the vehicle-device application 92 to configure and establish a reservation of a vehicle, such as vehicle 12. This establishment process can include using a user interface (such as a touchscreen and/or pushbuttons) of the personal SRWC device 90 and then sending this inputted information to the remote facility 80. The remote facility 80 can then access one or more databases, such as the vehicle reservation database, so that information can be obtained informing the remote facility 80 to either confirm or deny the reservation. The remote facility 80 can carry out subsequent communications with the personal SRWC device 90 and can then communicate the confirmation or denial of the reservation to the personal SRWC device 90. When the reservation is confirmed, the remote facility 80 can then send reservation information, such as reservation authentication and/or authorization information, to the personal SRWC device 90. At least some of this reservation information can then be presented by the personal SRWC device 90 to the vehicle 12 via a SRWC connection (e.g., a BLE connection). The vehicle can then authenticate and/or authorize access to the vehicle based on this reservation information. Thereafter, the vehicle can disengage the key lock of a key cylinder so that an ignition key can be removed from the key cylinder and used to start the vehicle.

With reference to FIG. 2, there is shown an embodiment of the vehicle key storage unit 100, which can be used with the vehicle 12. The vehicle key storage unit 100 includes a short-range wireless communication circuit 102, memory 104, a processor 106, a key cylinder unit 108, and battery 116. The vehicle key storage unit 100 can also include a housing 118 that houses or contains all of the components 102-116. The housing 118 of the vehicle key storage unit 100 includes an exposed portion that enables a keyway (or key hole) 111 of a key cylinder 112 to be exposed such that the blade 15 of a vehicle key 17 can be inserted into the key cylinder 112. In one embodiment, the housing 118 can be separate from any vehicle housing (referred to as a non-integrated vehicle key storage unit) and, in other embodiments, the vehicle key storage unit 100 can be connected physically and installed to housing of the vehicle 12 (referred to as an integrated vehicle key storage unit)—for example, the vehicle key storage unit 100 can be integrated into a center console of the vehicle 12 and between the driver seat and the front passenger seat. As another example, the key storage unit 100 may be integrated in with the actual ignition cylinder, such that key cylinder 112 is the same key cylinder used to start the vehicle's ignition or other primary mover. In another embodiment, the vehicle key storage unit 100 can be located within the vehicle 12 so that an individual cannot see the vehicle key storage unit 100 from an area external to the vehicle (or without having access into the passenger compartment of the vehicle).

The vehicle key storage unit 100 can be secured to the vehicle 12 to prevent the vehicle key storage unit 100 from being removed from the interior cabin of the vehicle. In one embodiment, a shackle and a separate lock that locks the shackle in a closed loop around a structural part of the vehicle (e.g., the metal frame of a vehicle seat) can be used to secure the vehicle key storage unit 100 to the vehicle 12 such that the vehicle key storage unit 100 cannot be removed from the vehicle without disengaging the separate lock from the shackle.

In one embodiment, the vehicle key storage unit 100 can include a printed circuit board (PCB) that includes the any one or more of the components 102-116 attached thereto and that can be used as a medium for connecting the various components 102-116. In at least some embodiments, the vehicle key storage unit 100 is an aftermarket device (i.e., a device that is not considered a part of the original OEM vehicle electronics) that is sent to or otherwise obtained by a vehicle (or P2P) manager after the vehicle (or P2P) manager applies to use or rent a vehicle as a part of the vehicle sharing network. Thus, in some embodiments, the vehicle key storage unit 100 is not part of the original OEM vehicle electronics and, thus, not required for normal operation of the vehicle by a user. Moreover, in some embodiments, the vehicle key storage unit 100 can include its own housing and can communicate with the vehicle electronics 20 (e.g., the wireless communications device 30) via the SRWC circuit 102.

The short-range wireless communication (SRWC) circuit 102 can be configured to communicate wirelessly according to one or more short-range wireless communications (SRWC) such as any of the Wi-Fi™, WiMAX™, Wi-Fi Direct™, other IEEE 802.11 protocols, ZigBee™, Bluetooth™, Bluetooth™ Low Energy (BLE), or near field communication (NFC). The short-range wireless communication (SRWC) circuit 102 enables the key storage unit 100 to transmit and receive SRWC signals, such as BLE signals. The SRWC circuit may allow key storage unit 100 to connect to another SRWC device, such as the wireless communications device 30 and/or the personal SRWC device 90.

In one embodiment, the SRWC circuit 102 can be used to connect the key storage unit 100 to the wireless communications device 30 via SRWC, such as BLE. The connection can be established upon the SRWC circuit 102 receiving a request to connect message from the wireless communications device 30 and, in this way, the SRWC circuit 102 can always be listening for this request message from the wireless communications device 30. A secure connection can be formed between the SRWC circuit 102 and the wireless communications device 30 through a handshake or other authentication process. The wireless communications device 30 can send a key lock request message over the SRWC connection to the vehicle key storage unit 100. The key lock request message can be a key lock engage request message or a key lock disengage message. The key lock engage request message is a request to engage the key lock 114 so that the key cylinder 112 is locked in the locked state (FIG. 3B) so that the key 17 cannot be removed. The key lock disengage request message is a request to disengage the key lock 114 so that the key cylinder 112 can be rotated freely within the cylinder mound 110 such as between the locked (or storage) position (FIG. 3B) and the unlocked (or removable) position (FIG. 3A).

In response to the key lock request message, the vehicle key storage unit 100 can send a key lock status message to the wireless communications device 30 that informs the wireless communications device 30 of the state of the key lock—that is, for example, whether the key lock is engaged (as shown in FIG. 3B) or disengaged (as shown in FIG. 3A). Also, in some embodiments, the wireless communications device 30 can send a key lock status inquiry message to the vehicle key storage unit 100 that queries whether the key lock is engaged or disengaged.

In other embodiments, the personal SRWC device 90 can establish a SRWC connection with the vehicle key storage unit 100 using similar techniques as those discussed above with respect to the connection between the wireless communications device 30 and the vehicle key storage unit 100. In such a case, the vehicle key storage unit 100 may establish a connection with the personal SRWC device 90 and the wireless communications device 30 of the vehicle 12. In this way, the wireless communications device 30 can send reservation information to the vehicle key storage unit 100, such as security information. The personal SRWC device 90 can receive corresponding security information as a part of establishing the reservation and this information can be sent along with a key lock request message from the personal SRWC device 90 to the vehicle key storage unit 100.

In an alternative embodiment, the vehicle key storage unit 100 can be hardwired into the vehicle so that the vehicle key storage unit 100 is connected to a communications bus of the vehicle 12, such as the communications bus 40. In such an embodiment, the vehicle key storage unit 100 may not include a SRWC circuit 102—however, in some embodiments, the vehicle key storage unit 100 can still include the SRWC circuit 102. Also, in some embodiments, the vehicle key storage unit 100 can be hardwired to a battery of the vehicle 12 and, thus, in such embodiments, the vehicle key storage unit 100 may not include the battery 116, or may use the battery 116 for backup in the case that the vehicle battery dies.

The processor 106 can be any type of device capable of processing electronic instructions including microprocessors, microcontrollers, host processors, controllers, vehicle communication processors, and application specific integrated circuits (ASICs). The processor 106 executes various types of digitally-stored instructions, such as software or firmware programs stored in memory 104, which enable the vehicle key storage unit 100 to provide a wide variety of services. For instance, processor 106 can execute programs or process data to carry out at least a part of the method discussed herein (e.g., method 300 (FIG. 5) and/or 400 (FIG. 6)). The memory 104 may include any suitable non-transitory, computer-readable medium; these include different types of RAM (random-access memory, including various types of dynamic RAM (DRAM) and static RAM (SRAM)), ROM (read-only memory), solid-state drives (SSDs) (including other solid-state storage such as solid state hybrid drives (SSHDs)), hard disk drives (HDDs), and magnetic or optical disc drives.

The battery 116 can be any suitable battery that can be used to power the electronic components of the vehicle key storage unit 100. In one embodiment, the battery 116 can be a lithium-ion (Li-ion) battery pack and in other embodiments the battery 116 can be a replaceable battery that is intended to be replaced after the battery is dead. In one embodiment, the battery 116 is rechargeable and, in such embodiments, the vehicle key storage unit 100 can include a power port (or cable (e.g., USB cable)) that can be connected to the auxiliary power supply 48 of the vehicle 12 and used to recharge the battery 116.

The key cylinder unit 108 includes a cylinder mount 110, the key cylinder 112, and a key lock 114. As mentioned above, the key lock can be any locking mechanism that locks a physical key within a key hole of the key storage unit when the key lock is in the locked (or engaged) position. In one embodiment, such as the embodiment shown in FIGS. 3A and 3B, the key lock 114 includes a deadbolt or locking member 115 that can be used to lock the key cylinder 112 in place such that the key cylinder 112 cannot be rotated. The key lock 114 can be engaged when the blade 15 of key 17 is placed into the keyhole 111 of the key cylinder 112 and the key cylinder is rotated into the lock position (see FIG. 3B). When the key cylinder 112 is in the lock position (or storage position), the pins (not shown) of the key cylinder 112 hold and lock the key 17 within the key cylinder 112 as the pins cannot back up from the key cuts of the key 17. When the key cylinder 112 is turned (or in) the unlocked (or removable) position (FIG. 3A), the key 17 can be removed since the pins can be retracted back within the key mount 110, for example. Also, when the key is in the unlocked position (FIG. 3A), the locking member 114 cannot be engaged since the locking member through-hole 113 of the key cylinder 112 is not aligned with the locking member 115 of the key lock 114. However, when the key 17 is inserted into the key cylinder 112 and turned to the locking position (FIG. 3B), the locking member through-hole 113 of the key cylinder 112 is aligned with the locking member 115 of the key lock 114 and, thus, the locking member 114 can be engaged through the locking member through-hole 113 of the key cylinder 112 and used to lock the key cylinder 112 in place.

The locking member 115 of the key lock 114 can be electrically-actuated and, as such, the key lock 114 is shown as being coupled with the processor 106. The key lock 114 can include a solenoid that is controlled through receiving signals from the processor 106. The processor 106 can send a key lock command, which can be a command to disengage (a key lock disengage command) or to engage (a key lock engage command) the key lock 114 (e.g., the locking member 115 of the key lock 114). Additionally or alternatively, the key lock 114 (or the key cylinder unit 108) can include a sensor to determine whether the key lock 114 is engaged or disengaged.

Also, at least in some embodiments, the key cylinder unit 108 can include a sensor that can determine the position of the key cylinder 112 relative to the cylinder mount 110. For example, this key cylinder position sensor can determine whether the key cylinder 112 is in the locked position (FIG. 3B) or the unlocked position (FIG. 3A). The sensor may be a set of electrical contacts that selectively switch states between at least two of the contacts to be either electrically shorted or isolated so as to indicate the cylinder position. Or, some other type of suitable sensor could be used. In one embodiment, the key cylinder 112 only includes two operable positions—the locked position (FIG. 3B) and the unlocked position (FIG. 3A). However, in other embodiments, the key cylinder 112 can include more than two positions.

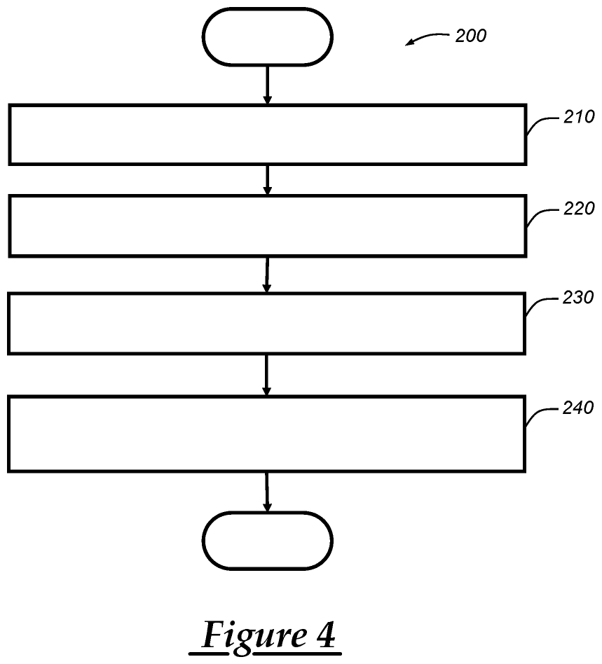

With reference to FIG. 4, there is shown an embodiment of a method 200 of establishing a reservation for a vehicle. In one embodiment, the method 200 can be carried out by the remote facility 80. Although the steps of the method 200 are described as being carried out in a particular order, it is hereby contemplated that the steps of the method 200 can be carried out in any suitable or technically feasible order as will be appreciated by those skilled in the art.

In step 210, a vehicle reservation request is received at a remote facility. The vehicle reservation request can include an identifier of a requested vehicle that a user desires to reserve (e.g., a VIN), a start time (and/or date), an end time (and/or date), user information (e.g., user credentials, user authentication information), and various other reservation parameters. A user can configure the reservation request using the personal SRWC device 90 (e.g., using vehicle-device application 92), or may do so using a computer 78. The user can use a graphical user interface (GUI) or other suitable input method. The reservation request can then be submitted to a vehicle backend services facility or other remote facility, which can then process the request. The method 200 continues to step 220.

In step 220, the remote facility determines whether to establish the reservation. The remote facility 80, for example, can recall information from databases 84, such as from the vehicle reservation database, and can determine whether to permit and/or establish the requested reservation. This determination can include checking for the requested vehicle's availability, determining whether the user is qualified to reserve the vehicle, comparing reservation parameters received in the reservation request to information pertaining to the requested vehicle, etc. When the remote facility determines to permit or otherwise establish the reservation, the method 200 continues to step 230. If the reservation is disallowed, the method 200 can end.

In step 230, the remote facility obtains or generates authentication and/or authorization information. The authentication information can be a digital certificate or certain parts of a digital certificate. In other embodiments, the authentication information can be other information suitable to authenticate a vehicle user or device (e.g., the personal SRWC device 90). The authorization information can include certain credential information, keys, or other secret information. In some embodiments, the authentication and authorization information can be aggregated into a single datum or data. The authentication and/or authorization information can be generated in response to determining to establish the reservation. In other embodiments, the authentication and/or authorization information can be pre-generated for a particular vehicle (or P2P user) and, thereafter, can be obtained or recalled from memory or a database, such as from the vehicle reservation database. In at least some embodiments where the authentication and/or authorization information is pre-generated for a particular vehicle (or P2P user), this information may only be sent to the personal SRWC device 90 (step 240).

Also, other reservation information can be obtained or generated. This information can include information concerning the reserved vehicle, information pertaining to the P2P or other vehicle user, and/or information pertaining to a device of the P2P or other vehicle user (e.g., the P2P vehicle renter), such as the personal SRWC device 90. For example, the reservation information can include authentication information, authorization information, a reservation identifier, vehicle identification information, and/or a personal SRWC device identification information. The reservation identifier can be a unique identifier that is used to uniquely identify the present reservation from other reservation. In other embodiments, the reservation identifier can be unique with respect to other reservation identifiers for a particular vehicle and, in this sense, the combination of a vehicle identification information and the reservation identifier can uniquely identify the present reservation. Other combinations of identifiers used to uniquely identify the each reservation of the P2P vehicle sharing network can be used as well. The vehicle identification information can include a vehicle identification number, a Bluetooth™ address (BD_ADDR) (e.g., a BD_ADDR of the SRWC circuit 32), a media access control (MAC) address (e.g., a MAC address of the SRWC circuit 32), or other identifier that can be used to identify the particular reserved vehicle. The personal SRWC device identification information can be an International Mobile Equipment Identity (IMEI) of the personal SRWC device 90, a phone number of the personal SRWC device 90, a MAC address of the personal SRWC device 90, a BD_ADDR of the personal SRWC device 90, or other identifying information of the personal SRWC device 90. The method 200 continues to step 240.

In step 240, the reservation information is sent to the personal SRWC device and/or the vehicle. The reservation information can include the authorization information, the authentication information, vehicle identification information, personal SRWC device identification information, and/or other reservation information (e.g., start and end times of the reservation). In one embodiment, the remote facility 80 can send the authorization information, the authentication information, and the vehicle identification information to the personal SRWC device 90. This information can be sent to the personal SRWC device 90 via the land network 76 and/or the cellular carrier system 70. Also, the remote facility 80 can send the personal SRWC device identification information and other reservation information to the vehicle, such as the reservation time period (e.g., start times and dates, end times and dates). In some embodiments, the vehicle 12 (or the vehicle electronics module) may already include authorization information and/or authentication information; in such embodiments, the remote facility 80 may not need to send this information to the vehicle 12. In other embodiments, however, the remote facility 80 can send the authorization information and/or authentication information, along with the personal SRWC device identification information and other reservation information, to the vehicle 12.

In one embodiment, the reservation information can include security information that is sent to the vehicle key storage unit 100 from the vehicle 12 via the SRWC circuit 32 and 102. Then, a personal SRWC device 90 can send corresponding security information to the vehicle key storage unit 100 via SRWC (e.g., BLE) and, in response, the vehicle key storage unit 100 can verify this information using the security information received from the vehicle 12—in this way, the vehicle key storage unit 100 can authenticate and authorize the personal SRWC device 90 to directly control operation of the key lock 114 (or other functions of the vehicle key storage unit 100) via the SRWC connection. The method 200 then ends.

With reference to FIG. 5, there is shown an embodiment of a method 300 of controlling a vehicle key storage unit at a vehicle. Although the steps of the method 300 are described as being carried out in a particular order, it is hereby contemplated that the steps of the method 300 can be carried out in any suitable or technically feasible order as will be appreciated by those skilled in the art.

In many embodiments, the method 300 can begin after the method 200 is carried out or after another vehicle reservation establishment process is carried out. Also, the method 300 can be carried out by the vehicle 12, such as by the wireless communications device 30. Prior to the method 200 and/or the method 300, the vehicle key storage unit 100 can be configured for operating with the vehicle 12. For example, a setup process for the vehicle key storage unit 100 can be carried out with the vehicle 12, which may include the exchange of information over the SRWC circuit or can include the vehicle 12 receiving information from a remote facility (e.g., security information used for controlling the vehicle key storage unit 100). In one embodiment, the vehicle key storage unit 100 and the vehicle 12 can carry out an initial SRWC connection establishment process or a pairing process in which the vehicle key storage unit 100 and the vehicle 12 (specifically, for example, the wireless communications device 30) establish a connection and then store connection information, such as a shared key that can be generated as a part of the initial SRWC connection establishment process or the pairing process. Moreover, as a part of the setup, other information can be shared between the vehicle key storage unit 100 and the vehicle 12. In other embodiments, the personal SRWC device 90 can carry out the method 300.

Additionally, the vehicle key storage unit 100 can be registered with a vehicle backend services facility, such as remote facility 80. In some embodiments, this registration can be carried out automatically by the vehicle key storage unit 100 and the vehicle 12, which can occur as a part of the initial setup. In other embodiments, a vehicle owner or primary operator can register the vehicle key storage unit 100 through use of a website, computer application, or other web-portal using, for example, computer 78 or personal SRWC device 90. This vehicle key storage unit registration process can include the vehicle owner or primary operator inputting information into a user interface. This inputted information can be information pertaining to the vehicle key storage unit 100 and/or the vehicle manager (or owner), as well as other information. Once the vehicle key storage unit 100 has been installed, registered, and/or otherwise setup, the vehicle key storage unit 100 is ready for use as a part of the peer-to-peer (P2P) vehicle sharing network.

The method 300 begins with step 310, wherein a vehicle user is detected at the vehicle. In one embodiment, the vehicle user can be considered to be detected when the wireless communications device 30 detects the presence of the personal SRWC device 90. For example, the wireless communications device 30 can periodically transmit an advertisement using the SRWC circuit 32 and, when the personal SRWC device 90 comes within range of the wireless communications device 30 and receives the advertisement, the personal SRWC device 90 can respond by sending an acknowledgement message (or a request to connect message). The personal SRWC device 90 and the wireless communications device can then establish a SRWC connection. In other embodiments, the personal SRWC device 90 can transmit the advertisements and, in response, the wireless communications device 30 can respond. Other embodiments are certainly possible. The method 300 continues to step 320.

In step 320, it is determined whether the vehicle user is authorized to access the vehicle. In one embodiment, after a SRWC connection is established between the personal SRWC device 90 and the wireless communications device 30, the personal SRWC device 90 can send reservation information, such as authentication and/or authorization information over the SRWC connection. In one embodiment, this information can include a cryptographic token that was sent to the personal SRWC device (and/or the vehicle 12) as a part of the reservation establishment process of method 200 (FIG. 4). Once the wireless communications device 30 receives the authentication and/or authorization information, the vehicle 12 can determine whether the personal SRWC device 90 (or vehicle user) is authenticated and whether the personal SRWC device 90 is authorized to access the vehicle (e.g., whether the vehicle user is authorized to access an interior cabin of the vehicle 12, or whether the vehicle user is authorized to open a door of the vehicle 12). When it is determined that the vehicle user is authorized to access the vehicle, the method 300 continues to step 330.

In step 330, the key lock of the vehicle key storage unit is disengaged. As used herein, disengaging a key lock refers to enabling or permitting a physical key to be removed from a key hole of a vehicle key storage unit. In one embodiment, disengaging the key lock includes actuating (or otherwise disengaging) the key lock so that a key cylinder of the vehicle key storage unit is permitted to rotate, such as to a position in which the key is removable from the key cylinder. For example, with reference to FIG. 3B, the key cylinder unit 108 is shown with the key lock 114 being engaged through the key cylinder 112. In FIG. 3B, the key cylinder 112 is considered to be in the locked position, which is a position of the key cylinder relative to the key cylinder mount 110 in which the key is not removable. And, since the key lock 114 is engaged, the key cylinder 112 cannot be rotated to the removable (or unlocked) position as shown in FIG. 3A. As mentioned above, in some embodiments, the key lock 114 includes a solenoid that can move the locking member 115 between a locked position (FIG. 3B) and an unlocked position (FIG. 3A)—in one embodiment, this step can include operating (e.g., activating or deactivating) the solenoid such that the locking member 115 retracts or otherwise moves out of the locking member through-hole 113 of the key cylinder 112 so that the key lock 114 is disengaged (e.g., in an unlocked or removable position). In other embodiments, the key lock 114 can include other electrically controlled mechanisms to secure and lock the key 17 within the key hole as will be appreciated by those skilled in the art.

In at least some embodiments, the vehicle key storage unit 100 is separate from the vehicle electronics 20. In such embodiments, the vehicle key storage unit 100 can establish a SRWC connection with the wireless communications device 30 (or other SRWC device of the vehicle 12 (or personal SRWC device 90)). Then, once the vehicle user is authenticated/authorized (step 320), the wireless communications device 30 (or other device) can send a key lock disengage command to the vehicle key storage unit 100 via the SRWC connection. This key lock disengage command can be sent over a secured SRWC connection and can include security information (e.g., a particular token or certificate) so that the vehicle key storage unit 100 can ensure that the command is sent from an authorized device (e.g., the vehicle 12, personal SRWC device 90). Once the vehicle key storage unit 100 receives key lock disengage command and validates/verifies the key lock disengage command, the vehicle key storage unit 100 can disengage the key lock 114, as described above. The vehicle key storage unit 100 can send an acknowledgment message when the command is received. Additionally, or alternatively, the vehicle key storage unit 100 can send a key lock status message that indicates a status of the key cylinder unit 108 or the key lock 114, such as whether the key lock is engaged, the position of the key cylinder, and/or whether the key is engaged in the key cylinder.

In other embodiments, the vehicle key storage unit 100 can be hardwired to the communications bus 40 (or other communications bus or VSM). In such embodiments, the key lock disengage command can be sent by a VSM (e.g., the BCM 24 or the wireless communications device 30) via the hardwire connection (e.g., the communications bus 40) to the vehicle key storage unit 100. Once the vehicle key storage unit 100 receives key lock disengage command and validates/verifies the key lock disengage command, the vehicle 12 can disengage the key lock 114, as described above. Also, the vehicle key storage unit 100 can send a key lock status message and/or acknowledgment message to the VSM (or other VSM) of the vehicle 12. The method 300 then ends.

With reference to FIG. 6, there is shown an embodiment of a method 400 of controlling a vehicle key storage unit at a vehicle. Also, the method 400 is an embodiment of a method of securing a physical vehicle key at a vehicle. The method 400 can be carried out a processor of an electronic control unit that is located at the vehicle. In one embodiment, the method 400 is carried out by the wireless communications device 30 and/or the vehicle key storage unit 100, each of which is considered an electronic control unit. In another embodiment, the method 400 is carried out by the personal SRWC device 90. Although the steps of the method 400 are described as being carried out in a particular order, it is hereby contemplated that the steps of the method 400 can be carried out in any suitable or technically feasible order as will be appreciated by those skilled in the art.

In many embodiments, the method 400 can begin after the method 200 and/or the method 300 is carried out. Also, the method 400 can be carried out by the vehicle 12, such as by the wireless communications device 30. In one scenario, the method 200 can be carried out to establish a reservation and, then, the method 300 can be carried out at the start of the reservation so that a vehicle user can remove the key 17 from the key cylinder 112 and then use the key for operating the vehicle—for example, after the key lock is disengaged (step 330 of method 300), the vehicle user can rotate the key 17 (and, thus, the key cylinder 112) to the unlocked (or removable) position and then remove the key 17. The key 17 can then be inserted into the key ignition cylinder 42 of the vehicle 12 that can be used to start the vehicle 12. Then, the method 400 can be carried out at the end of the reservation in which the method can be used to lock the key 17 in the key cylinder 112—for example, as discussed more below, at the end of the reservation, the vehicle user places the key 17 into the key cylinder 112 and rotates the key 17 to the locked (or storage) position (FIG. 3B) and then the key lock can be engaged to lock the cylinder in this position such that the key cylinder cannot be rotated to the unlocked or removable position and the key removed. In this way, it can be ensured that the key 17 for the vehicle 12 is left at the vehicle 12 by the vehicle user when the reservation is ended.

In step 410, it is determined to engage the key lock of the vehicle key storage unit. As mentioned above, in some embodiments, it can be determined to engage the key lock 114 of the vehicle key storage unit 100 when a vehicle sharing (e.g., car sharing or P2P) reservation has ended. In one embodiment, the vehicle 12 can receive a reservation end message from the personal SRWC device 90 or the remote facility 80. For example, the vehicle user can select an “End Reservation” option using application 92 on their personal SRWC device 90 and, in response, the vehicle 12 can be notified that the reservation has ended (or is being ended). This indication can be sent directly to the vehicle using the SRWC connection (between the wireless communications device 30 and the device 90) or can be sent to the vehicle via the remote facility 80. Once the vehicle 12 receives this message, the vehicle can determine to engage the key lock 114 of the vehicle key storage unit 100. In other embodiments, the remote facility 80 can send a key lock engage request to the vehicle 12 (which can then forward the request to the vehicle key storage unit 100). And, in another embodiment, the vehicle 12 can determine to engage the key lock based on sensor information from one or more onboard vehicle sensors. For example, the vehicle 12 can detect that the time of the reservation is near and that the vehicle user has departed from the vehicle. In other embodiments, the personal SRWC device 90 can determine whether to engage the key lock of the vehicle key storage unit based on whether the user has selected the “End Reservation” option using application 92 and/or based on whether it is detected that the reservation has ended.

In step 420, it is determined whether the vehicle key storage unit is in a lockable state. In many embodiments, this step can include determining whether the key cylinder is in the locked position (or that the vehicle key storage unit is in a state in which the key lock can otherwise be engaged). In other embodiments, the vehicle key storage unit may include a key hole but not a rotatable key cylinder and, in such embodiments, it can be determined that the vehicle key storage unit is in a lockable state when it is determined that the key is within the key hole (assuming this is the state in which the key lock can be engaged to lock the key within the key hole). In one embodiment, the vehicle 12 can send a key cylinder state request message to the vehicle key storage unit 100 via the SRWC connection and, in response, the vehicle key storage unit 100 can determine the state of the key cylinder 112, such as by receiving sensor information pertaining to a position of the key cylinder 112 relative to the key cylinder mount 110. The vehicle key storage unit 100 then sends a key cylinder status message to the vehicle 12 indicating whether the key cylinder is in the locked (or storage) position. When it is determined that the key cylinder is in the locked (or storage) position, the method proceeds to step 440; otherwise, the method 400 continues to step 430.

In another embodiment, once it is determined to engage the key lock, the vehicle 12 can send a key lock engage command to the vehicle key storage unit 100 via the SRWC connection between the vehicle key storage unit 100 and the wireless communications device 30 (or via another communications path, such as a hardwired connection as is the case in other embodiments). In this embodiment, the vehicle 12 can send the key lock engage command/request to the vehicle key storage unit 100, which can then determine whether the key cylinder is in the locked (or storage) position. If it is determined at the vehicle key storage unit 100 that the key cylinder is in the locked (or storage) position, the key lock 114 can be engaged so that the key cylinder 112 locked (FIG. 3B) and the vehicle 12 can be informed that the key is secured (or that the key lock is engaged). Since the key cylinder 112 is locked in place, the key cylinder 112 cannot be rotated back to the unlocked (or removable) position (FIG. 3A) and the key 17 removed. If it is determined that the key cylinder is not in the locked (or storage) position (e.g., in the unlocked (or removable) position), the vehicle key storage unit 100 can notify the vehicle 12 that the key cylinder is in the unlocked (or removable) position or that the key cylinder 114 is not otherwise in the locked (or storage) position; the method 400 can then proceed to step 430.

In many embodiments, the vehicle 12 can continuously keep track of the key cylinder status (e.g., whether the key cylinder is in the locked (or storage) position) and whether the key lock is engaged (or disengaged). In such embodiments, the vehicle can readily make the determination of whether the key cylinder is in the locked position (or that the vehicle key storage unit is in a state in which the key lock can otherwise be engaged). And, in some embodiments, this key cylinder status or key lock status can be communicated to the personal SRWC device 90 and/or the remote facility 80 so that these devices also can readily determine whether the key cylinder is in the locked position (or that the vehicle key storage unit is in a state in which the key lock can otherwise be engaged). In such embodiments, the personal SRWC device 90, the vehicle 12, and/or the remote facility 80 can store a vehicle key storage unit status indicator in memory (e.g., memory 38) that indicates the key lock status and/or the key cylinder status. Then, upon reaching step 420, the device (e.g., the personal SRWC device 90, the vehicle 12, the remote facility 80) can inspect the vehicle key storage unit status indicator to determine whether the key cylinder is in the locked position (or that the vehicle key storage unit is in a state in which the key lock can otherwise be engaged). The method then continues to step 440 when it is determined that the key cylinder is in the locked position (or that the vehicle key storage unit is in a state in which the key lock can otherwise be engaged (i.e., the lockable state)); otherwise, the method 400 continues to step 430.

In step 430, the vehicle user is informed or notified to place the physical vehicle key in the key hole. In some embodiments, the determination of step 410 and/or 420 can be made by the personal SRWC device 90 and, in such embodiments, the personal SRWC device 90 can automatically generate and present a notification to the vehicle user based on these determinations. In another embodiment, the steps 410 and/or 420 can be carried out by the vehicle 12 or the remote facility 80 and, in such embodiments, the vehicle 12 or the remote facility 80 can send a notification to the personal SRWC device 90, which can then present the notification to the vehicle user (e.g., using a display or audio speaker). In other embodiments, the vehicle 12 or the remote facility 80 can send an indicator that directs the personal SRWC device 90 to display the notification to the user—this indicator can also be considered a notification as it results in the notification being presented. In one embodiment, the notification can include a message that informs the vehicle user to place the key 17 in the key cylinder 112 and rotate the key cylinder 112 to the locked position.

As mentioned above, the vehicle key storage unit 100 can continuously monitor the key cylinder position and/or detect a change in the key cylinder position and this is represented by the loop from step 430 back to step 430. Once it is determined that the key cylinder is in the locked position (or that the vehicle key storage unit is in a state in which the key lock can otherwise be engaged (i.e., the lockable state of the key lock)), the method 400 proceeds to step 440.

In step 440, the key lock of the vehicle key storage unit is engaged. As used herein, engaging a key lock refers to locking a physical key within a vehicle key storage unit so that the physical key cannot be removed from the vehicle key storage unit. In one embodiment, engaging the key lock includes actuating (or otherwise engaging) the key lock so that a key cylinder of the vehicle key storage unit is prevented from being rotated by a user. For example, with reference to FIG. 3A, the key cylinder unit 108 is shown with the key lock 114 being disengaged from the key cylinder 112. When the vehicle user inserts the key 17 and rotates the key cylinder 112 to the locked (or storage) position (FIG. 3B), the locking member 115 can be moved through the locking member through-hole 113 so that the key cylinder 112 is locked in place as shown in FIG. 3B. When the key lock is engaged, the key cylinder 112 cannot be rotated to the removable (or unlocked) position as shown in FIG. 3A. As mentioned above, in some embodiments, the key lock 114 includes a solenoid that can move the locking member 115 between a locked position (FIG. 3B) and an unlocked position (FIG. 3A)—in one embodiment, this step can include operating (e.g., activating or deactivating) the solenoid such that the locking member 115 extends or otherwise moves into the locking member through-hole 113 of the key cylinder 112 so that the key lock 114 is engaged (e.g., in an unlocked or removable position). In other embodiments, the key lock 114 can include other electrically controlled mechanisms to secure and lock the key 17 within the key cylinder 112 as will be appreciated by those skilled in the art.

This step can include receiving a key lock engage command/request from the vehicle 12, the personal SRWC device 90, and/or the remote facility (e.g., via the personal SRWC device 90 or the vehicle 12). For example, the vehicle 12 can send a key lock engage command via the SRWC connection (or the hardwired connection) to the vehicle key storage unit 100, which can then verify the authenticity/authorization conveyed in the message and, once verified/validated, the key lock 114 can be engaged. In another embodiment, the personal SRWC device 90 can send a key lock engage command via the SRWC connection (between the vehicle key storage unit 100 and the personal SRWC device 90) to the vehicle key storage unit 100, which can then verify the authenticity/authorization conveyed in the message and, once verified/validated, the key lock 114 can be engaged. Once the key lock is engaged, the vehicle key storage unit 100 can send a vehicle key storage unit status indicator to the vehicle 12, the personal SRWC device 90, and/or the remote facility 80. The method 400 then ends.

In some embodiments, after step 410, it can be determined that a predetermined amount of time has passed since the determination of step 410 was made and, then, the vehicle 12 (or personal SRWC device 90) can notify the remote facility 80 that the key is not at the vehicle (when it is supposed to be, such as at the end of the reservation). Additionally or alternatively, the vehicle manager (or owner) can be notified by the remote facility 80 and/or the vehicle 12 that the key has not been returned or at least not properly stored in the vehicle key storage unit 100.

In some embodiments, the vehicle manager (or owner) can send a key lock engage request using the vehicle 12 or their personal SRWC device to the vehicle key storage unit 100 and, then, steps 420 through 430 can be carried out. And, in another embodiment, the vehicle manager (or owner) can send a key lock disengage request using the vehicle 12 or their personal SRWC device to the vehicle key storage unit 100 and, then, the step 330 can be carried out so that the key lock is disengaged. In yet another embodiment, the remote facility 80 can send a key lock disengage request to the vehicle 12, which can then send a key lock disengage request/command to the vehicle key storage unit 100 so that the key lock is disengaged.

In some embodiments, as mentioned above, the key lock status and/or the key cylinder status can continuously be monitored by the vehicle key storage unit 100 and reported to the vehicle 12 and/or the personal SRWC device 90. In one embodiment, the application 92 of the personal SRWC device 90 can indicate the key lock status and/or the key cylinder status and/or report these status(es) to the remote facility 80.

In one embodiment, the method 200, the method 300, the method 400, and/or parts thereof can be implemented in one or more computer programs (or “applications”, or “scripts”) embodied in a computer readable medium and including instructions usable (e.g., executable) by one or more processors of the one or more computers of one or more systems. The computer program(s) may include one or more software programs comprised of program instructions in source code, object code, executable code, or other formats. In one embodiment, any one or more of the computer program(s) can include one or more firmware programs and/or hardware description language (HDL) files. Furthermore, the computer program(s) can each be associated with any program related data and, in some embodiments, the computer program(s) can be packaged with the program related data. The program related data may include data structures, look-up tables, configuration files, certificates, or other relevant data represented in any other suitable format. The program instructions may include program modules, routines, programs, functions, procedures, methods, objects, components, and/or the like. The computer program(s) can be executed on one or more computers, such as on multiple computers that are in communication with one another.

The computer program(s) can be embodied on computer readable media (e.g., memory of one or more servers at the remote facility 80, memory 104 of the vehicle key storage unit 100, memory 38 of the wireless communications device 30), which can be non-transitory and can include one or more storage devices, articles of manufacture, or the like. Exemplary computer readable media include computer system memory, e.g. RAM (random access memory), ROM (read only memory); semiconductor memory, e.g. EPROM (erasable, programmable ROM), EEPROM (electrically erasable, programmable ROM), flash memory; magnetic or optical disks or tapes; and/or the like. The computer readable medium may also include computer to computer connections, for example, when data is transferred or provided over a network or another communications connection (either wired, wireless, or a combination thereof). Any combination(s) of the above examples is also included within the scope of the computer-readable media. It is therefore to be understood that the method can be at least partially performed by any electronic articles and/or devices capable of carrying out instructions corresponding to one or more steps of the disclosed method.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. A method of securing a physical vehicle key at a vehicle, wherein the method is carried out by one or more electronic processors located at the vehicle, the method comprising the steps of:
determining whether a vehicle key storage unit is in a lockable state, wherein the vehicle key storage unit includes a key hole for inserting the physical vehicle key and is located at the vehicle;
when it is determined that the vehicle key storage unit is not in the lockable state, sending a notification to a vehicle user informing the vehicle user to place the physical vehicle key in the key hole; and
when it is determined that the vehicle key storage unit is in the lockable state, engaging a key lock of the vehicle key storage unit so that the physical vehicle key is locked in and not removable from the key hole.

2. The method of claim 1, wherein the vehicle key storage unit includes a key cylinder that is moveable between a locked position and an unlocked position and wherein it is determined that the vehicle key storage unit is in the lockable state when it is determined that the key cylinder is in the locked position.

3. The method of claim 2, wherein the key cylinder is a non-ignition key cylinder.

4. The method of claim 3, wherein the vehicle key storage unit is an aftermarket device that includes the one or more electronic processors and that is separate from vehicle electronics of the vehicle.

5. The method of claim 3, wherein the vehicle key storage unit includes a short-range wireless communications (SRWC) circuit, and wherein the vehicle key storage unit receives a key lock engage command from a wireless communications device of the vehicle or from a personal SRWC device.

6. The method of claim 5, wherein the determining step is carried out in response to an indication that a vehicle sharing reservation has ended.

7. The method of claim 6, wherein the indication that the vehicle sharing reservation has ended is received from the personal SRWC device and in response to the vehicle user indicating an end of the reservation via a device-user interface of the personal SRWC device.

8. The method of claim 5, wherein the notification is sent to the wireless communications device of the vehicle or the personal SRWC device via the SRWC circuit of the vehicle key storage unit.

9. The method of claim 2, wherein the key cylinder is an ignition key cylinder of the vehicle and wherein the locked position of the key cylinder is a dedicated key storage position for purposes of storing the physical vehicle key when the vehicle is not being operated.

10. The method of claim 1, further comprising the step of disengaging the key lock of the vehicle key storage unit in response to receiving a key lock disengage request message.

11. The method of claim 10, wherein the key lock disengage request message is sent in response to determining that the vehicle user is authorized to access the vehicle.

12. The method of claim 11, wherein the key lock disengage request message is sent in response to detecting that the vehicle user is at the vehicle.

13. The method of claim 1, wherein the determining step is carried out by vehicle electronics of the vehicle or wherein the determining step is carried out by the vehicle key storage unit.

14. A vehicle key storage unit for securing a physical vehicle key at a vehicle, comprising:
a key lock that is operable between an engaged state and a disengaged state;
a key hole that is configured to receive the physical vehicle key for the vehicle;
a processor; and
memory communicatively coupled to the processor, wherein the memory stores a computer program;
wherein the processor operates under control of the computer program to cause the vehicle key storage unit to:
engage the key lock so that the key lock is set to the engaged state in response to receiving a key lock engage command from a vehicle or a personal short-range wireless communications (SRWC) device, wherein the key lock in the engaged state locks the physical vehicle key in the key hole such that the physical vehicle key is prevented from being removed from the key hole; and
disengage the key lock in response to receiving a key lock disengage command from the vehicle or the personal short-range wireless communications (SRWC) device.

15. The vehicle key storage unit of claim 14, wherein the vehicle key storage unit is an aftermarket device.

16. The vehicle key storage unit of claim 14, wherein the vehicle key storage unit includes a housing that is separate from the vehicle.

17. The vehicle key storage unit of claim 14, wherein the vehicle key storage unit further includes a short-range wireless communications (SRWC) circuit.

18. The vehicle key storage unit of claim 14, wherein the vehicle key storage unit further includes a key cylinder in which the key hole is located, and wherein key cylinder is moveable between a locked position and an unlocked position.

19. The vehicle key storage unit of claim 18, wherein the processor operates under the control of the computer program to cause the vehicle key storage unit to engage the key lock when it is determined that the key cylinder is in the locked position.

20. The vehicle key storage unit of claim 14, wherein the vehicle key storage unit is hardwired to a communications bus of a vehicle.
